(19) United States
(12) Patent Application Publication
(10) Pub. No.: US 2018/0120622 A1
(43) Pub. Date: May 3, 2018

(54) DISPLAY DEVICE

(71) Applicant: SHARP KABUSHIKI KAISHA, Sakai City, Osaka (JP)

(72) Inventors: JUNICHI MASUDA, Sakai City (JP); KENTA FUKUOKA, Sakai City (JP)

(21) Appl. No.: 15/570,213

(22) PCT Filed: Apr. 21, 2016
(86) PCT No.: PCT/JP2016/062620

§ 371 Date: Oct. 27, 2017

(30) Foreign Application Priority Data
Apr. 28, 2015 (JP) 2015-092013

(51) Int. Cl. G02F 1/1347; G09G 3/36; G02F 1/1335

(52) U.S. Cl. CPC G02F 1/13471; G02F 2001/133567; G02F 1/133603; G09G 3/36

(57) ABSTRACT

Provided is a display device allowing a background to be seen through a display with appropriate brightness on the back side of the display. An auxiliary light source driver circuit is controlled so as to adjust the brightness of auxiliary light, such that on the back side of the display, the sum of the brightness of source light transmitted through a light guide to the back side and the brightness of auxiliary light, where the backlight source is on, is equal to the brightness of auxiliary light where the backlight source is off. As a result, the difference in brightness on the back side depending on whether the backlight source (80) is on or off further decreases, whereby background display quality is further inhibited from changing.

### TECHNICAL FIELD

The present invention relates to display devices, particularly to a display device provided with a display through which a background can be seen.

### BACKGROUND ART

Currently, display devices provided with displays (see-through displays) through which backgrounds can be seen are being developed actively. For such displays, there have been proposed various modes, including modes in which a liquid crystal panel is used and modes in which an organic EL panel is used.

For example, FIG. 14 is a diagram illustrating the configuration of a conventional liquid crystal display device in which a background can be seen through a liquid crystal unit 201. The liquid crystal display device, as described in Patent Document 1, includes, in addition to the liquid crystal unit 201, a front polarizer 202 and a rear polarization unit 203, which are opposed with respect to the crystal unit 201, and also includes a background illumination unit 205, as shown in FIG. 14; the background illumination unit 205 emits illumination to an exhibit 204 disposed in a gap provided between the liquid crystal unit 201 and the rear polarization unit 203, whereby the exhibit 204 can be easily seen through the liquid crystal unit 201. Thus, the observer on the front side of the liquid crystal display device can see an image displayed on the liquid crystal unit 201 and can even clearly see the exhibit 204.

### CITATION LIST

### Patent Document

Patent Document 1: Japanese Laid-Open Patent Publication No. 2014-130270

### SUMMARY OF THE INVENTION

### Problems to be Solved by the Invention

However, in the case of the liquid crystal display device described in Patent Document 1, the background illumination unit 205 illuminates the exhibit 204 with constant brightness regardless of the brightness in the gap where the exhibit 204 is disposed, with the result that the exhibit 204 is illuminated with excessive brightness, so that power consumption is increased, or the exhibit 204 is illuminated with insufficient brightness and therefore cannot be seen clearly. Moreover, in the case where the background illumination unit 205 driven in a field-sequential mode, if the observer on the back side of the liquid crystal display device changes his/her line of sight, the observer might see color breakup and/or flicker due to backlight and/or illumination transmitted through to the back side.

Therefore, an objective of the present invention is to provide a display device allowing a background to be seen through a display with appropriate brightness on the back side of the display while making it less likely for an observer on the back side of the display to feel stress.

### Means for Solving the Problems

A first aspect of the present invention is directed to a display device having a function of allowing a background to be seen through from a front side, the device including:

a backlight source configured to emit source light;

a display portion configured to display an image by transmitting the source light emitted by the backlight source therethrough in accordance with an externally provided image signal, the display portion being capable of transmitting background light incident from a back side therethrough to the front side;

a drive control circuit configured to drive the display portion;

an auxiliary light source configured to emit auxiliary light toward a back of the display portion; and

an auxiliary light source driver circuit configured to drive the auxiliary light source, wherein,

the auxiliary light source driver circuit drives the auxiliary light source in synchronization with the backlight source.

A second aspect of the present invention provides the display device according to claim 1, wherein the auxiliary light source driver circuit drives the auxiliary light source such that the auxiliary light is brighter when the backlight source is off than when the backlight source is on.

A third aspect of the present invention provides the display device according to claim 2, wherein the auxiliary light source driver circuit drives the auxiliary light source such that the sum of the amount of source light emitted by the backlight source and transmitted through to the back side and the amount of auxiliary light provided when the backlight source is on equals the amount of auxiliary light provided when the backlight source is off.

A fourth aspect of the present invention provides the display device according to claim 1, wherein,

the drive control circuit provides the display portion with image data generated on the basis of the image signal for each of a plurality of sub-field periods delineated by dividing one frame period at the image signal,

the backlight source and the auxiliary light source each include a plurality of light-emitting elements configured to emit light in at least three respectively different colors,

the backlight source emits source light by lighting up at least one of the light-emitting elements for each of the sub-field periods in synchronization with the drive control circuit providing the display portion with the image data generated on the basis of the image signal, and

the auxiliary light source driver circuit causes at least one of the light-emitting elements included in the auxiliary light source to emit auxiliary light in synchronization with the backlight source for each of the sub-field periods, such that the auxiliary light has a complementary color to the source light emitted by the backlight source.

A fifth aspect of the present invention provides the display device according to claim 4, wherein, the auxiliary light source driver circuit drives the auxiliary light source such that light consisting of the source light transmitted from the backlight source to the back side and the auxiliary light emitted by the auxiliary light source toward the back side has chromaticity coordinates of the same color among the sub-field periods.

A sixth aspect of the present invention provides the display device according to claim 4, wherein the auxiliary light source driver circuit drives the auxiliary light source to emit auxiliary light such that the sum of the amount of light transmitted from the backlight source to the back side and the amount of auxiliary light emitted by the auxiliary light source toward the back side is constant among the sub-field periods.

A seventh aspect of the present invention provides the display device according to any of claims 4 through 6, wherein the auxiliary light source driver circuit drives the auxiliary light source to emit auxiliary light in a consistent color among the sub-field periods where the backlight source is off.

An eighth aspect of the present invention provides the display device according to any of claims 1 through 7 wherein, the display portion is a liquid crystal panel, and the light-emitting elements included in each of the backlight source and the auxiliary light source are light-emitting elements respectively emitting red, green, and blue light.

### Effect of the Invention

In the first aspect of the present invention, the auxiliary light source is driven in such a manner as to change the brightness of illumination on the back of the display portion in synchronization with the on and off states of the backlight source. Thus, thus the transparency of the display portion increases, with the result that the observer sees the background through the display portion more easily.

In the second aspect of the present invention, the auxiliary light source is controlled so as to be brighter when the backlight source is off than when the backlight source is on. Thus, the difference in brightness of the display portion in transparent state depending on whether the backlight source on or off decreases, whereby background display quality is inhibited from changing.

In the third aspect of the present invention, the auxiliary light source driver circuit is controlled so as to adjust the brightness of auxiliary light, such that on the back side of the display portion, the sum of the brightness of source light transmitted through to the back side and the brightness of auxiliary light, where the backlight source is on, is equal to the brightness of auxiliary light where the backlight source is off. Thus, the difference in brightness in transparent state depending on whether the backlight source is on or off further decreases, whereby background display quality is further inhibited from changing.

In the fourth aspect of the present invention, the display device has the display portion driven in a field-sequential mode, and causes the auxiliary light source to emit auxiliary light to the back side for each sub-field period, such that the auxiliary light has a complementary color to the color of source light emitted by the backlight source. Thus, even when the observer on the back side of the display portion changes his/her line of sight, the observer sees less color breakup where the source light is perceived as being in separate colors, and therefore, is less likely to feel stress.

In the fifth aspect of the present invention, the auxiliary light source is driven such that the light on the back side of the display portion has the same chromaticity coordinates among the sub-field periods. Thus, even when the observer on the back side of the display portion changes his/her line of sight, the observer sees less color breakup, and therefore, is less likely to feel stress.

In the sixth aspect of the present invention, the auxiliary light source is controlled such that the sum of the amounts of light transmuted through to the back side of the display portion is equalized among the sub-field periods. As a result, the observer on the back side of the display portion does not perceive the amount of light to vary among the sub-field periods, and therefore, does not see flicker. Thus, the observer is less Likely to feel stress.

In the seventh aspect of the present invention, when the backlight source is off, the light emitted in the same color by the auxiliary light source is the only light on the back side in any of the sub-field periods. Thus, even when the observer on the back side of the display portion changes his/her line of sight, the observer does not see color breakup, and therefore, is less likely to feel stress.

The eighth aspect of the present invention renders it possible for liquid crystal display devices to achieve the same effects as the above.

### BRIEF DESCRIPTION OF THE DRAWINGS

FIG. 1 is a block diagram illustrating the configuration of a liquid crystal display device according to a first embodiment.

FIG. 2 is a diagram illustrating the configuration of a backlight source included in the liquid crystal display device according to the first embodiment.

FIG. 3 is a diagram illustrating the configuration of an auxiliary light source included in the liquid crystal display device according to the first embodiment.

FIG. 4 is a cross-sectional view illustrating the configuration of a display included in the liquid crystal display device according to the first embodiment, as viewed from the side.

FIG. 5 is a view illustrating the configuration of a light guide included in the liquid crystal display device according to the first embodiment.

FIG. 6 provides diagrams illustrating display states of the display included in the liquid crystal display device according to the first embodiment; more specifically, part (A) is a diagram illustrating the display state of the display where the backlight source is on, and part (B) is a diagram illustrating the display state of the display where the backlight source is off.

FIG. 7 is a diagram demonstrating that the display is rendered in transparent state in the liquid crystal display device according to the first embodiment where the backlight source is on.

FIG. 8 is a diagram demonstrating that the display is rendered in transparent state in the liquid crystal display device according to the first embodiment where the backlight source is off.

FIG. 9 is a diagram illustrating the amounts of auxiliary light in a liquid crystal display device according to a second embodiment where a backlight source is on and also off.

FIG. 10 is a diagram illustrating lighting states of a backlight source and an auxiliary light source in a liquid crystal display device according to a third embodiment for each sub-field period.

FIG. 11 is a diagram illustrating lighting states of a backlight source and an auxiliary light source in a liquid crystal display device according to a fourth embodiment for each sub-field period.

FIG. 12 is a diagram describing the sum of the amount of source light transmitted through to the back side of a display and the amount of auxiliary light in a liquid crystal display device according to a fifth embodiment for each sub-field period.

FIG. 13 is a diagram illustrating the state of light emission by an auxiliary light source in a liquid crystal display device according to a sixth embodiment for each sub-field period where a backlight source is off.

FIG. 14 is a diagram illustrating the configuration of a conventional liquid crystal display device with a liquid crystal unit through which a background can be seen.

### MODES FOR CARRYING OUT THE INVENTION

### 1. First Embodiment

### 1.1 Configuration of the Liquid Crystal Display Device

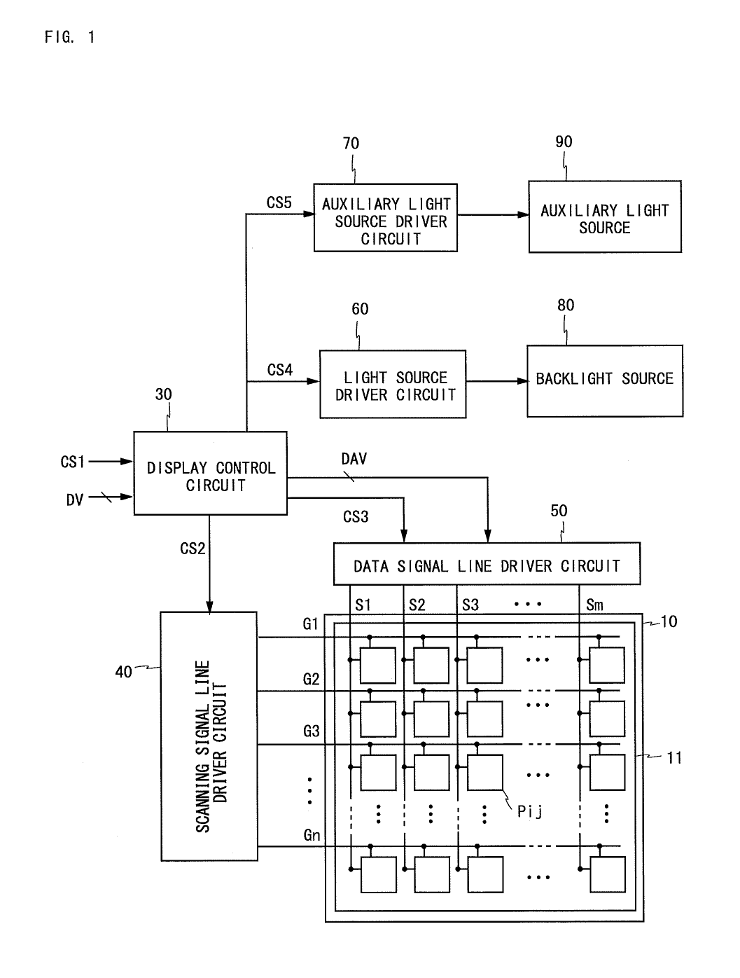

FIG. 1 is a block diagram illustrating the configuration of liquid crystal display device according to a first embodiment. As shown in FIG. 1, the liquid crystal display device is an active-matrix display device provided with a display 10, which is capable of see-through display, a display control circuit 30, a scanning signal line driver circuit 40, a data signal line driver circuit 50, a light source driver circuit 60, an auxiliary light source driver circuit 70, a backlight source 80, and an auxiliary light source 90. Note that the display 10 includes a liquid crystal panel 11 and also includes polarizers and a light guide, and the configuration of the display 10 will be described later.

The liquid crystal panel 11 included in the display 10 has formed thereon n scanning signal lines G₁ to Gₙ, m data signal lines S₁ to Sₘ, and (m×n) pixels Pᵢⱼ. Here, n and m are integers of 2 or more, i is an integer of from 1 to m, and j is an integer of from 1 to n. The scanning signal lines G₁ to Gₙ are disposed parallel to one another, and the data signal lines S₁ to Sₘ are disposed parallel to one another so as to cross the scanning signal lines G₁ to Gₙ. Disposed near the intersection of the scanning signal line Gᵢ and the data signal line Sⱼ is the pixel Pᵢⱼ. In this manner, the (m×n) pixels Pᵢⱼ are disposed in a matrix with each row consisting of m pixels and each column consisting of n pixels. The scanning signal line Gᵢ is connected in common to the m pixels Pᵢⱼ disposed in the i′th row, and the data signal line Sⱼ is connected in common to the n pixels Pᵢⱼ disposed in the j′th column. Moreover, the liquid crystal panel 11 has color filters (not shown) formed thereon in order to display an image in color.

The display control circuit 30 of the liquid crystal display device is externally provided with control signals CS1, such as horizontal synchronization signals and vertical synchronization signals, as well as an image signal DV. On the basis of these signals, the display control circuit 30 outputs control signals CS2 to the scanning signal line driver circuit 40 and control signals CS3 and image data DAV to the data signal line driver circuit 50.

Furthermore, on the basis of the image signal DV and the control signals CS1, the display control circuit 30 generates control signals CS4 and CS5 to control the light source driver circuit 60 and the auxiliary light source driver circuit 70, and provides the signals to the light source driver circuit 60 and the auxiliary light source driver circuit 70, respectively. The light source driver circuit 60 drives the backlight source 80 in accordance with the control signal CS4, and the auxiliary light source driver circuit 70 drives the auxiliary light source 90 in accordance with the control signal CS5, such that the auxiliary light source 90 operates in synchronization with the backlight source 80. As a result, the backlight source 80 emits backlight from the back side toward the liquid crystal panel 11. The auxiliary light source 90 emits auxiliary light toward the back side of the display 10, such that the auxiliary light changes brightness in synchronization with the on/off status of the backlight source 80.

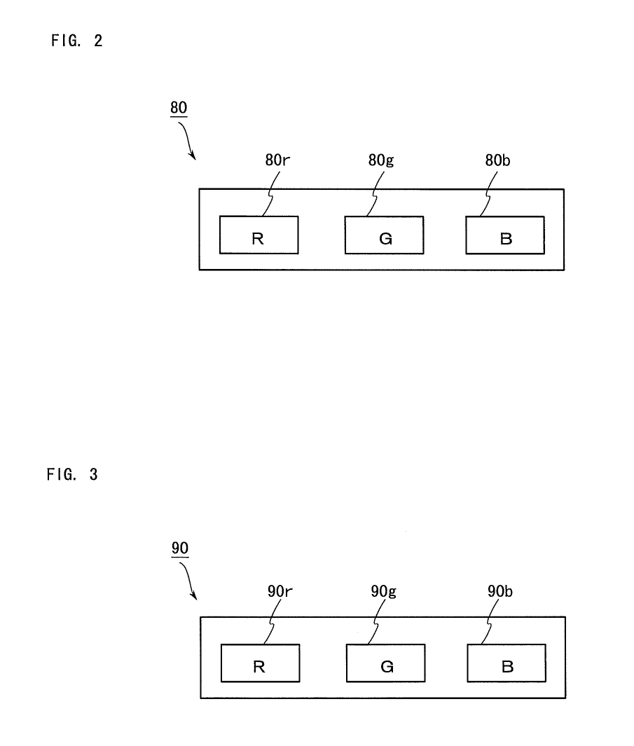

FIG. 2 is a diagram illustrating the configuration of the backlight source 80. As shown in FIG. 2, the backlight source 80 consists of three types of LEDs (light-emitting diodes), which are an LED 80r for emitting red (R) light, an LED 80g for emitting green (G) light, and an LED 80b for emitting blue (B) light, and the backlight source 80 is attached to an edge of the light guide included in the display 10, as will be described later. In the present embodiment, these LEDs are lit up simultaneously, but may be lit up one color after another in a time-division manner. Note that for the backlight source 80, CCFLs (cold cathode fluorescent lamps) may be used in place of the LEDs. These LEDs and CCFLs will also be referred to collectively as the “light-emitting elements” of the backlight source 80.

FIG. 3 is a diagram illustrating the configuration of the auxiliary light source 90. As shown in FIG. 3, the auxiliary light source 90 also consists of three types of LEDs, which are an LED 90r for emitting red (R) light, an LED 90g for emitting green (G) light, and an LED 90b for emitting blue (B) light, and the auxiliary light source 90 is attached to an edge of the light guide or the liquid crystal panel 11 included in the display 10, such that auxiliary light can be emitted toward the back side of the display 10. In the present embodiment, these LEDs are lit up simultaneously, but may be lit up one color after another in a time-division manner. Note that the auxiliary light source 90 may be attached to a wall near the display 10, rather than to the display 10. These LEDs will also be referred to collectively as the “light-emitting elements” of the auxiliary light source 90.

The scanning signal line driver circuit 40 provides a high-level output signal sequentially to the scanning signal lines G₁ to Gₙ. As a result, the scanning signal lines G₁ to Gₙ are sequentially selected one by one, with the result that pixels Pᵢⱼ for one row are collectively selected upon selection of each scanning signal line. The data signal line driver circuit 50 generates a signal voltage on the basis of the image data DAV, and applies the signal voltage to the data signal lines S₁ to Sₘ at times determined by the control signals CS3. As a result, the signal voltage in accordance with the image data DAV is written to m pixels Pᵢⱼ for each selected row. In this manner, the signal voltage is written to the pixels connected to the scanning signal lines, with the result that the liquid crystal display device displays an image on the liquid crystal panel 11. Note that the display control circuit 30, the scanning signal line driver circuit 40, and the data signal line driver circuit will also be referred to collectively as the “drive control circuits”.

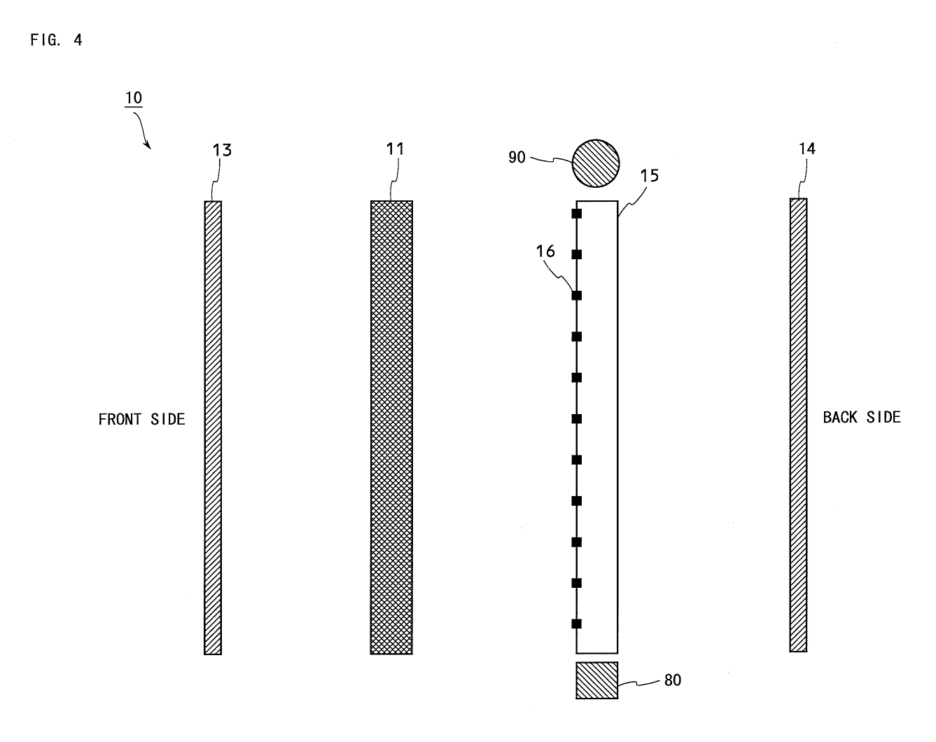

FIG. 4 is a cross-sectional view illustrating the configuration of the display 10 as viewed from the side. As shown in FIG. 4, the display 10 has sequentially disposed, from the front to the back side, an absorptive polarizer 13, the liquid crystal panel 11, the light guide 15, and a reflective polarizer 14. The light guide 15 has the backlight source 80 attached at the bottom edge and the auxiliary light source 90 attached at the top edge. The auxiliary light source 90 emits auxiliary light to directly illuminate the back side of the display 10 without being transmitted through the reflective polarizer 14. Note that the auxiliary light source 90 may be attached to the top edge of the liquid crystal panel 11. Moreover, the display 10 will also be referred to as the “display portion”.

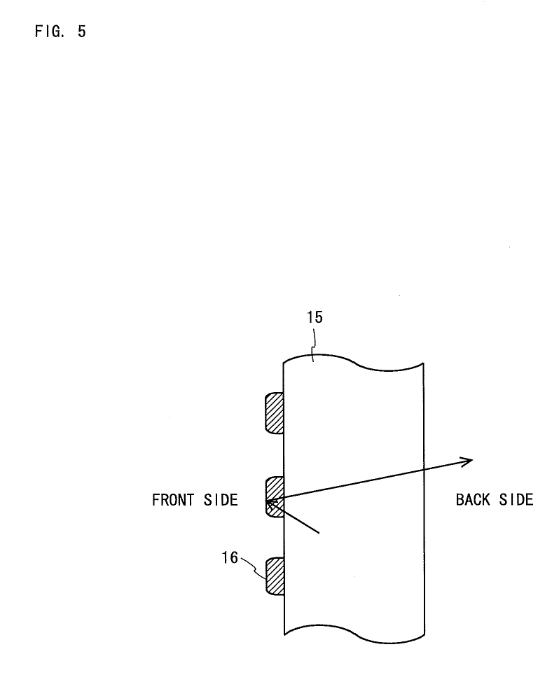

FIG. 5 is a cross-sectional view illustrating in cross section the light guide 15 included in the liquid crystal display device. As shown in FIG. 5, the light guide 15 has reflectors 16 only on the front-side surface to reflect light propagating through the light guide 15. Examples of the method for forming the reflector 16 include inkjet printing with transparent ink and injection by which transparent resin is cast into a mold in the shape of the reflector 16. The reflector 16 is formed by any of the methods using a material with the same or approximately the same refractive index as the composing material of the light guide 15. Accordingly, source light propagating through the light guide 15 is incident on the reflector 16 without being refracted at the boundary between the reflector 16 and the light guide 15, and is reflected by the surface of the reflector 16. The reflected light propagates without its polarization being disturbed, and is emitted from the back-side surface of the light guide 15 toward the reflective polarizer 14.

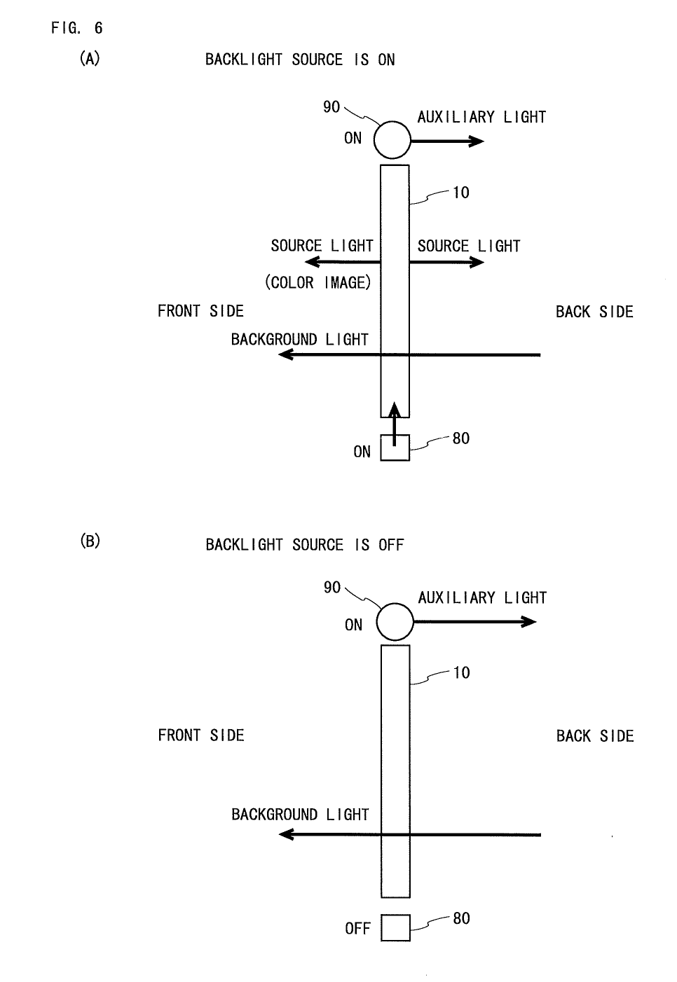

FIG. 6 provides diagrams illustrating display states of the display 10 shown in FIG. 4; more specifically, FIG. 6(A) is a diagram illustrating the display state of the display 10 where the backlight source 80 is on, and FIG. 6(B) is a diagram illustrating the display state of the display 10 where the backlight source 80 is off.

As shown in FIG. 6(A), when the backlight source 80 is on (at the time of backlight-on), source light from the backlight source 80 is incident on the light guide 15. The source light incident on the light guide 15 is transmitted through to the front side, with the result that the observer on the front side can see a color image. Moreover, some polarization component of the source light reflected by the reflectors 16 formed on the front-side surface of the light guide 15 is transmitted through the reflective polarizer 14 to the back side. On the other hand, background light incident on the display 10 from the back side is transmitted through the display 10 to the front side. As a result, the observer on the front side can see the background. Moreover, the auxiliary light source 90 emits auxiliary light toward the back side in order to illuminate the background, and therefore, the observer can see the background clearly.

Furthermore, as shown in FIG. 6(B), when the backlight source 80 is off, the source light is not emitted from the display 10 toward the front side. Accordingly, the observer on the front side cannot see a color image. However, the background light is transmitted through to the front side as in the case shown in FIG. 6(A), and therefore, the observer on the front side can see the background. Moreover, the auxiliary light source 90 emits auxiliary light toward the back side in order to illuminate the background, and therefore, the observer can see the background clearly.

### 1.2 Transparent State of the Display

Before describing the transparent state of the display 10, prerequisites will be described. First, the following description will be given on the premise that both the source light and the auxiliary light are linearly polarized light. The linearly polarized light includes a polarization component whose electric field vibrates parallel to the plane of incidence and a polarization component whose electric field vibrates vertically to the plane of incidence. Accordingly, herein, the polarization component whose electric field vibrates parallel to the plane of incidence will also referred to as the “first polarization component”, and the polarization component whose electric field vibrates vertically to the plane of incidence will also be referred to as the “second polarization component”. In this case, the polarization direction of the first polarization component and the polarization direction of the second polarization component are perpendicular to each other. Note that the source light and the auxiliary light do not have to be linearly polarized light, and may be, for example, circularly polarized light or elliptically polarized light.

Furthermore, the reflective polarizer 14 has a transmission axis along which incident light is transmitted and a reflection axis along which incident light is reflected, and these axes are perpendicular to each other. Similarly, the absorptive polarizer 13 has a transmission axis along which incident light is transmitted and an absorption axis along which incident light is absorbed, and these axes are also perpendicular to each other. Accordingly, it is assumed herein that the polarization direction of the first polarization component is parallel to the transmission axis of the reflective polarizer 14 and the transmission axis of the absorptive polarizer 13, and the polarization direction of the second polarization component is parallel to the reflection axis of the reflective polarizer 14 and the absorption axis of the absorptive polarizer 13. Therefore, the first polarization component is transmuted through the reflective polarizer 14 or the absorptive polarizer 13 upon incidence thereon, whereas the second polarization component is reflected by the reflective polarizer 14 upon incidence thereon or absorbed by the absorptive polarizer 13 upon incidence thereon. Moreover, the absorptive polarizer 13 and the reflective polarizer 14 shown in FIG. 4 are assumed to be disposed with their transmission axes parallel to each other. As a result, the first polarization component transmitted through the reflective polarizer 14 is transmitted through the absorptive polarizer 13 as well unless the polarization direction changes.

It should be noted that the second polarization component may be transmitted through the reflective polarizer 14 and the absorptive polarizer 13, and the first polarization component may be reflected by the reflective polarizer 14 and absorbed by the absorptive polarizer 13. Moreover, the reflective polarizer 14 and the absorptive polarizer 13 may be disposed with their absorption axes perpendicular to each other.

Furthermore, the liquid crystal that is sealed in the liquid crystal panel 11 will be described herein as being TN (twisted nematic) liquid crystal. The TN liquid crystal rotates the polarization direction of incident light in accordance with a signal voltage being written to the pixel Pᵢⱼ, and therefore, for example, when the first polarization component is incident on the pixel Pᵢⱼ, the first polarization component is rotated by an angle of rotation in accordance with a signal voltage being written in the pixel Pᵢⱼ, with the result that the first polarization component is converted into light containing the first polarization component and the second polarization component at a ratio in accordance with the angle of rotation. However, for the sake of better understanding, in the following description, the first polarization component that is incident on a pixel Pᵢⱼ with a signal voltage being written thereto (i.e., the pixel Pᵢⱼ is in on-state) is converted into a second polarization component, and the second polarization component that is incident on such a pixel is converted into a first polarization component. Note that the liquid crystal that is sealed in the liquid crystal panel 11 may be VA (vertical alignment) liquid crystal. In this case, the first or second polarization component incident on the liquid crystal panel 11 changes in angle of phase difference in accordance with the signal voltage being written to the pixel Pᵢⱼ, but any description thereof will be omitted.

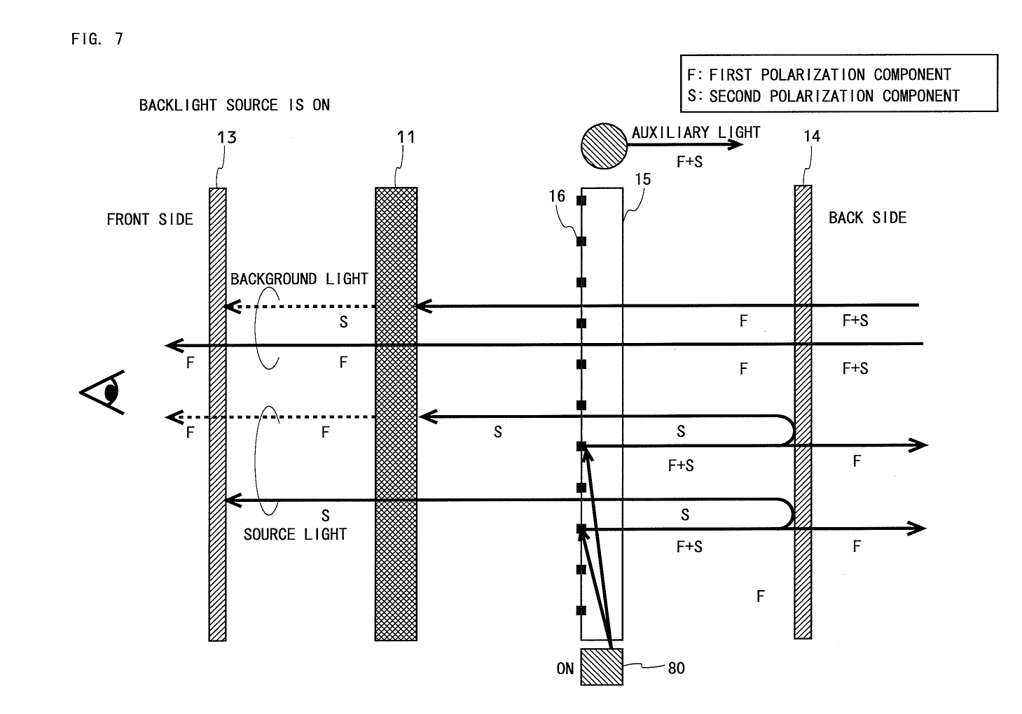

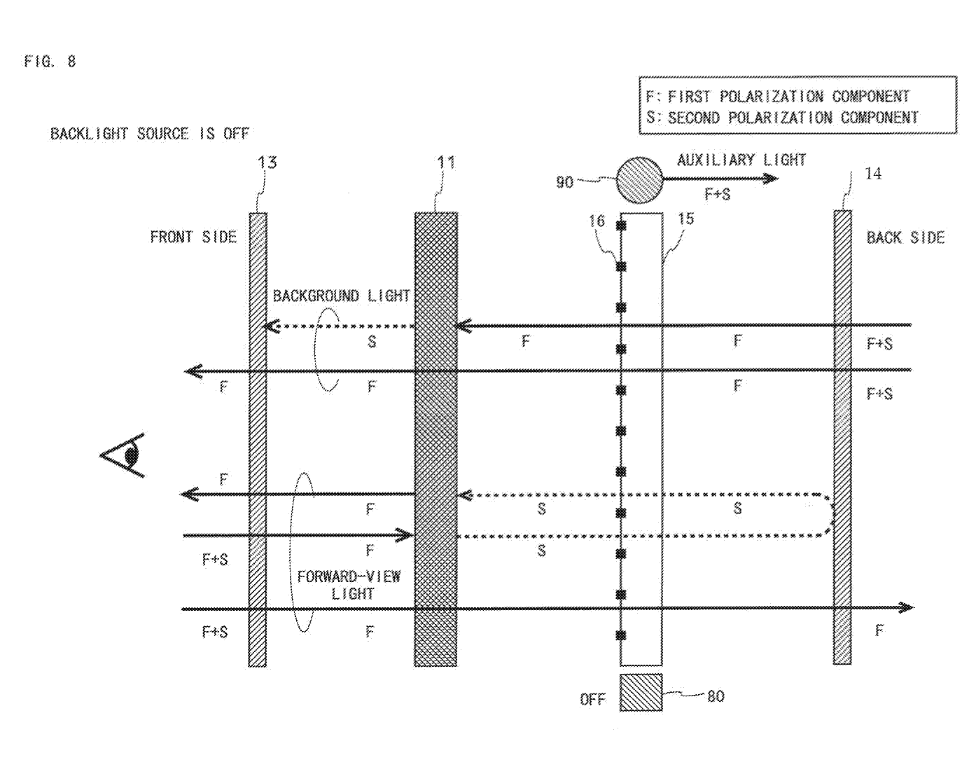

Next, the case where the display 10 is rendered in transparent state will be described regarding separate situations where the backlight source 80 is on and where the backlight source 80 is off. Described first is the situation where the backlight source 80 is on. FIG. 7 is a diagram demonstrating that the display 10 is rendered in transparent state where the backlight source 80 is on. As shown in FIG. 7, the light guide 15 has the reflectors 16 formed on the front-side surface. Source light emitted by the backlight source 80 includes a first polarization component F and a second polarization component S. When the source light is incident on the light guide 15, the source light travels inside the light guide 15 while experiencing total reflection on the opposite surfaces of the light guide 15. If the source light is incident on the reflector 16 during the travel inside the light guide 15, the source light is reflected by the reflector 16, and emitted from the back-side surface of the light guide toward the reflective polarizer 14.

Because the polarization direction of the first polarization component F is parallel to the transmission axis of the reflective polarizer 14, once the source light is incident on the reflective polarizer 14, the first polarization component F is transmitted through the reflective polarizer 14 to the back side. On the other hand, because the polarization direction of the second polarization component S is parallel to the reflection axis of the reflective polarizer 14, the second polarization component S is reflected by the reflective polarizer 14, and is incident on the liquid crystal panel 11 after being transmitted through the light guide 15. The second polarization component S that is incident on on-state pixels has the polarization direction rotated upon incidence, with the result that the second polarization component S is converted into a first polarization component F. The liquid crystal panel 11 emits the resultant first polarization component F toward the absorptive polarizer 13. absorptive polarizer 13 transmits the first polarization component F therethrough, and therefore, the source light reaches the front side of the display 10.

Furthermore, in the case where the second polarization component S reflected by the reflective polarizer 14 is incident on off-state pixels, the second polarization component S is emitted toward the absorptive polarizer 13 without the polarization direction being rotated. The absorptive polarizer 13 absorbs the second polarization component S, and therefore, the source light does not reach the front side of the display 10.

On the other hand, when background light which contains a first polarization component F and a second polarization component S is incident from the back side, the second polarization component S is reflected by the reflective polarizer 14, and the first polarization component F is transmitted through the reflective polarizer 14 and the light guide 15, and is incident on the liquid crystal panel 11. In this case, if the first polarization component F is incident on off-state pixels, the first polarization component F is emitted from the liquid crystal panel 11 without the polarization direction being rotated, and is incident on the absorptive polarizer 13. The absorptive polarizer 13 transmits the first polarization component F therethrough, and therefore, the background light reaches the front side of the display 10.

Furthermore, the first polarization component F that is incident on on-state pixels has the polarization direction rotated upon incidence, and is emitted from the liquid crystal panel 11 as the second polarization component S, which is to be incident on the absorptive polarizer 13. The absorptive polarizer 13 absorbs the second polarization component S, and therefore, the background light does not reach the front side of the display device.

In this manner, when the light source is on, the source light and the background light are respectively transmitted through the on-state and off-state pixels of the liquid crystal panel 11 to the front side of the display 10, with the result that the observer on the front side can see both an image displayed on the display 10 and the background of the display 10.

Described next is the situation where the backlight: source 80 is off. FIG. 8 is a diagram demonstrating that the display 10 is rendered in transparent state where the backlight source 80 is off. As shown in FIG. 8, the transmission state of the background light is the same as in the above situation where the backlight source 80 is on, and therefore, any description thereof will be omitted.

Described now is the case where forward-view light, which represents a view forward from the front side, is incident from the front side of the display 10. The forward-view light also includes a first polarization component F and a second polarization component S, and therefore, when the forward-view light is incident on the absorptive polarizer 13, the second polarization component S is absorbed by the absorptive polarizer 13, with the result that only the first polarization component F is transmitted and is incident on the liquid crystal panel 11. The first polarization component F that is incident on on-state pixels is converted into a second polarization component S by the polarization direction being rotated. The second polarization component S is emitted from the liquid crystal panel 11 and is incident on the reflective polarizer 14 after being transmitted through the light guide 15. The reflective polarizer 14 reflects the second polarization component S incident thereon. The reflected second polarization component S is transmitted through the light guide 15 to on-state pixels of the liquid crystal panel 11. The second polarization component S that is incident on the on-state pixels is converted into a first polarization component F by the polarization direction being rotated. The first polarization component F is emitted from the liquid crystal panel 11. The absorptive polarizer 13 transmits the first polarization component F therethrough, and therefore, the forward-view light is transmitted through the absorptive polarizer 13 to the front side.

Furthermore, some of the first polarization component F transmitted through the absorptive polarizer 13 is incident on off-state pixels of the liquid crystal panel 11, and is transmitted sequentially through the liquid crystal panel 11, the light guide 15, and the reflective polarizer 14 to the back side without the polarization direction being rotated.

As described above, when the backlight source 80 is off, the background light incident from the back side of the display 10 is transmitted through the off-state pixels to the front side, and some polarization component of the forward-view light incident from the front side of the display 10 is transmitted through the on-state pixels, and thereafter is reflected and transmitted to the front side. Thus, the observer on the front side of the display 10 can see the background of the display 10, and also see a mirrored forward view.

### 1.3 Method for Driving the Auxiliary Light Source

Described next is the situation where the auxiliary light source 90 is on. When the display 10 is in transparent state, the auxiliary light source 90 is turned on, thereby illuminating the background more brightly. As a result, the amount of light that is transmitted through to the back side increases, with the result that the observer on the front side of the display 10 can see the background more easily.

In this case, the brightness of the auxiliary light source 90 varies depending on whether the backlight source 80 is on (i.e., at the time of backlight-on) or off (i.e., at the time of backlight-off). More specifically, the display control circuit 30 changes the operation of the auxiliary light source driver circuit 70 in synchronization with the switching between on and off of the backlight source 80 by the light source driver circuit 60, such that the brightness of the auxiliary light source 90 is higher at the time of backlight-off than at the time of backlight-on. As a result, the difference in brightness on the back side depending on whether the backlight source is on or off decreases, resulting in a reduced difference in background brightness in transparent state.

### 1.4 Effects

In the present embodiment, when the auxiliary light source 90 illuminates the back of the display 10, the brightness of the auxiliary light source 90 illuminating the back of the display 10 is changed in synchronization with the on and off times of the backlight source 80. As a result, the transparency of the display 10 increases, so that the observer can see the background through the display 10 more easily.

Furthermore, the brightness of the auxiliary light source 90 is controlled so as to be higher when the backlight source 80 is off than when the backlight source 80 is on. Thus, the difference in brightness in transparent state depending on whether the backlight source 80 is on or off decreases, whereby display quality in transparent state can be inhibited from changing.

### 2. Second Embodiment

The configuration of a liquid crystal display device according to a second embodiment and the configuration of the display 10 included in the liquid crystal display device are the same as the configuration of the liquid crystal display device shown in FIG. 1 and the configuration of the display 10 shown in FIG. 4, respectively, and therefore, any descriptions thereof will be omitted.

Furthermore, in the case of the display 10 of the crystal display device according to the present embodiment, the color display and the transparent state at the time of backlight-on and the mirror display and the transparent state at the time of backlight-off are the same as those described in the first embodiment in conjunction with the backlight-on and the backlight-off, and therefore, any descriptions thereof will also be omitted. Note that in the present embodiment, as in the first embodiment, color filters are formed on the surface of the liquid crystal panel 11. Moreover, the light emitted by both the backlight source 80 and the auxiliary light source 90 is white light obtained by lighting up the red, green, and blue LEDs simultaneously.

### 2.1 Method for Driving the Auxiliary Light Source

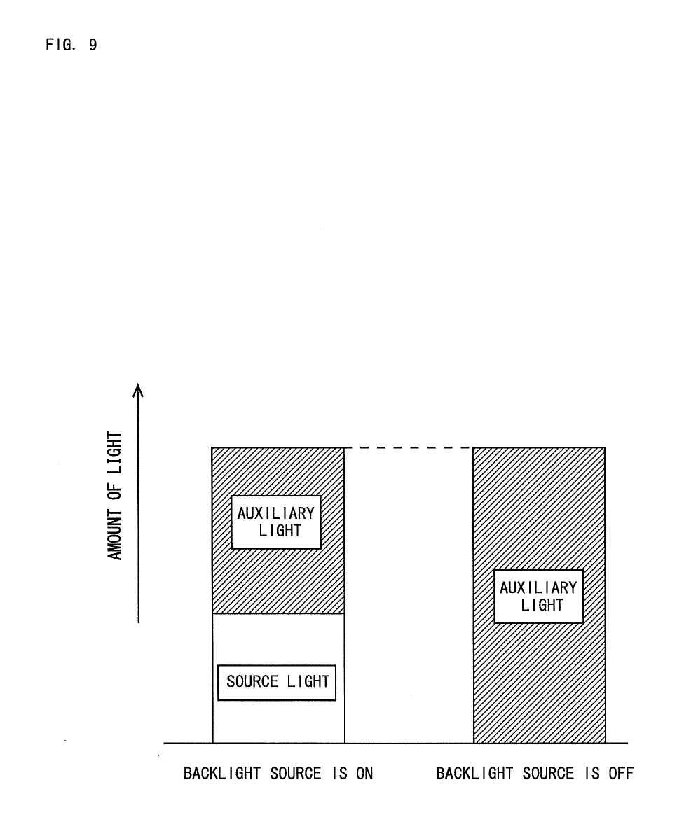

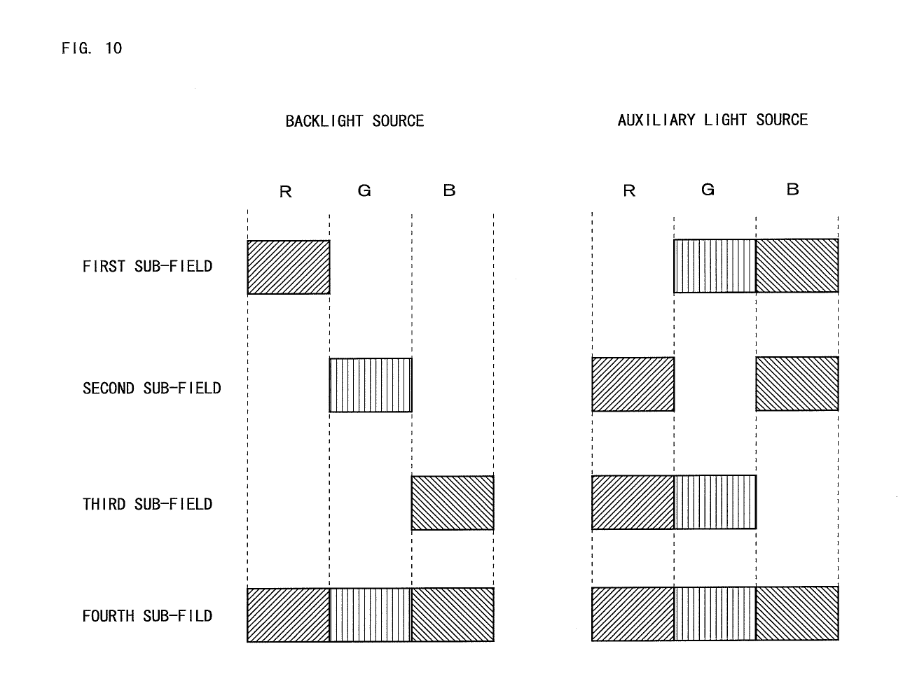

FIG. 9 is a diagram illustrating the amounts of auxiliary light where the backlight source 80 is on and also off. As shown in FIG. 9, when the backlight source 80 is on, the first polarization component of the source light emitted from the light guide 15 is transmitted through the reflective polarizer 14 to the back side. On the other hand, when the backlight source 80 is off, no source light is transmitted through to the back side. Accordingly, to equalize the amount of light transmitted through to the back side between the time of backlight-on and the time of backlight-off, the auxiliary light source 90 is controlled such that the amount of auxiliary light emitted toward the back side by the auxiliary light source 90 where the backlight source is off equals the sum of the amount of auxiliary light emitted toward the back side by the auxiliary light source 90 and the amount of polarization component derived from the light source and transmitted to the back side, where the backlight source is on. As a result, even at the time of backlight-off, the display 10 illuminated from the back side with the same amount of auxiliary light as that at the time of backlight-on, and therefore, regardless of whether the backlight source 80 is in on or off state, the brightness on the back side at the time of backlight-off can be kept at the same level as that at the time of backlight-on.

### 2.2 Effects

In the present embodiment, the auxiliary light source driver circuit 70 is controlled so as to adjust the brightness of auxiliary light, such that on the back side of the display 10, the sum of the brightness of the auxiliary light and the brightness of the source light transmitted through the light guide 15 to the back side, where the backlight source 80 is on, equals the brightness of the auxiliary light where the backlight source 80 is off. As a result, the difference in brightness on the back side depending on whether the backlight source 80 is on or off further decreases, and therefore, background display quality can be further inhibited from changing.

### 3. Third Embodiment

The configuration of a liquid crystal display device according to a third embodiment and the configuration of the display 10 included in the liquid crystal display device are the same as the configuration of the liquid crystal display device shown in FIG. 1 and the configuration of the display 10 shown in FIG. 4, respectively, except for the features to be described below, and therefore, any descriptions of the same features will be omitted. However, in the present embodiment, unlike in the first embodiment, no color filters are formed on the surface of the liquid crystal panel 11, and the backlight source 80 and the auxiliary light source 90 light up the red, green, and blue LEDs sequentially in a time-division manner. As a result, the liquid crystal panel 11 is driven in a field-sequential mode, such that red, green, and blue light are sequentially transmitted therethrough in accordance with an image signal DV, with the result that the observer on the front side of the display 10 can see both a color image and a background.

### 3.1 Method for Driving the Auxiliary Light Source

In the case where the liquid crystal panel 11 is driven in a field-sequential mode, the first polarization component of the source light emitted by the backlight source 80 in each sub-field period is transmitted to the back side through the reflective polarizer 14 disposed behind the light guide 15. Accordingly, when the observer on the back side of the display 10 changes his/her line of sight, color breakup occurs where the source light emitted by the backlight source 80, which varies in color among the sub-field periods, is perceived as being in separate colors. Described in the present embodiment. therefore is a method in which color breakup is inhibited by using the auxiliary light source 90.

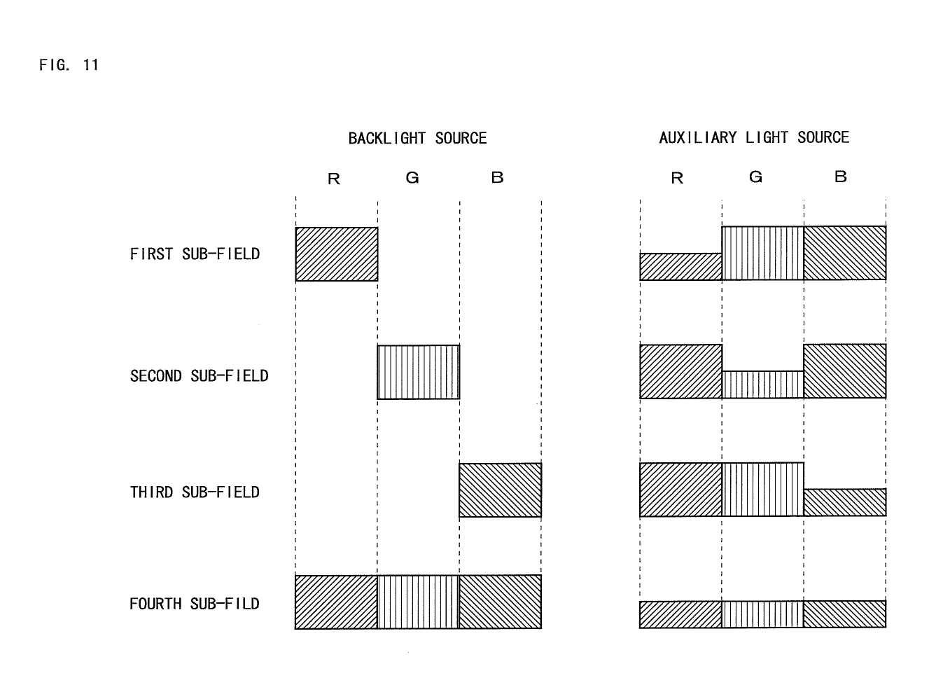

FIG. 10 is a diagram illustrating lighting states of the backlight source 80 and the auxiliary light source 90 for each sub-field period. As shown in FIG. 10, one frame period consists of four sub-field periods, i.e., first through fourth sub-field periods. For each sub-field period, the LEDs of the auxiliary light source 90 are lit up such that the color of light emitted by the auxiliary light source 90 is complementary to the color of light emitted by the backlight source 80. Specifically, in the sub-field periods, the LEDs of the auxiliary light source 90 are lit up in the following manner.

In the first sub-field period, the red LED of the backlight source 80 is lit up, and therefore, the auxiliary light source 90 lights up the green and blue LEDs simultaneously in order to emit light in cyan (C), which is a complementary color to red. In the second frame, the green LED of the backlight source 80 is lit up, and therefore, the auxiliary light source 90 lights up the red and blue LEDs simultaneously in order to emit light in magenta (M), which is a complementary color to green. In the third frame, the blue LED of the backlight source 80 is lit up, and therefore, the auxiliary light source 90 lights up the red and green LEDs simultaneously in order to emit light in yellow (Y), which is a complementary color to blue. Then, in the fourth sub-field period, the backlight source 80 lights up the red, green, and blue LEDs simultaneously, thereby emitting white light, and therefore, the auxiliary light source 90 lights up the red, green, and blue LEDs simultaneously in order to emit white light (W) as well.

In this manner, in synchronization with light emitted by the backlight source 80 in each sub-field period, the auxiliary light source 90 emits light in a complementary color thereto, with the result that the observer on the back side of the display 10 simultaneously sees the source light transmitted through the reflective polarizer 14 and the auxiliary light emitted by the auxiliary light source 90. Thus, even when the observer changes his/her line of sight, it is possible to inhibit the occurrence of color breakup where the light emitted in an individual color by the backlight source 80 in each sub-field period is perceived as being in separated colors.

### 3.2 Effects

In the present embodiment, in the liquid crystal display device including the liquid crystal panel 11 driven in a field-sequential mode, for each sub-field period, the auxiliary light source 90 emits auxiliary light toward the back side in a complementary color to the color of the source light emitted by the backlight source 80. Thus, even when the observer on the display 10 changes his/her line of sight, the observer sees less color breakup where the source light is perceived as being in separate colors, and therefore, is less likely to feel stress.

### 3.3 Variant

The order of the colors of the source light emitted by the backlight source 80 in the sub-field periods is not limited to the order: red, green, blue, and white, and may be, for example, blue, green, red, and white. Moreover, the light emitted by the backlight source 80 is not limited to a single color of light, and may be provided in sequential combinations of a plurality of colors. In this manner, the backlight source 80 is simply required to be a light source capable of emitting light in at least three colors. In any case, the auxiliary light source 90, in synchronization with the backlight source 80, emits auxiliary light sequentially in complementary colors to the source light in the sub-field periods. Moreover, one frame period is not limited to consisting of four sub-field periods, and may consist of any plural number of sub-field periods.

### 4. Fourth Embodiment

The configuration of a liquid crystal display device according to a fourth embodiment and the configuration of the display 10 included in the liquid crystal display device are the same as the configuration of the liquid crystal display device shown in FIG. 1 and the configuration of the display 10 shown in FIG. 4, respectively, except for the features to be described below, and therefore, any descriptions of the same features will be omitted. Moreover, as with the liquid crystal display device according to the third embodiment, the liquid crystal display device according to the present embodiment is driven in a field-sequential mode in which red, green, and blue light are sequentially emitted in a time-division manner, therefore, no color filters are formed on the surface of the liquid crystal panel 11, and the backlight source 80 and the auxiliary light source 90 light up the red, green, and blue LEDs sequentially in a time-division manner.

### 4.1 Method for Driving the Auxiliary Light Source

In the case where the liquid crystal display device is driven in a field-sequential mode, when the light transmitted through to the back side of the display 10 is not white light in any sub-field periods, the observer on the back side is more likely to feel stress due color breakup caused by the observer changing his/her line of sight.

In the case of the liquid crystal display device according to the present embodiment, in order not to cause color breakup even when the observer on the back side changes his/her line of sight, the chromaticity coordinates of light transmitted through to the back side of the display 10 are set to match the chromaticity coordinates (0.2585, 0.2914) for white in each sub-field period. In the present embodiment, coordinates on. a chromaticity diagram for red (R), green (G), and blue (B) light emitted by the LEDs of the auxiliary light source 90 are, for example, as shown below but are not limited to the following:

R=(0.3744, 0.2616)

G=(0.2880, 0.5543)

B=(0.1623, 0.0804)

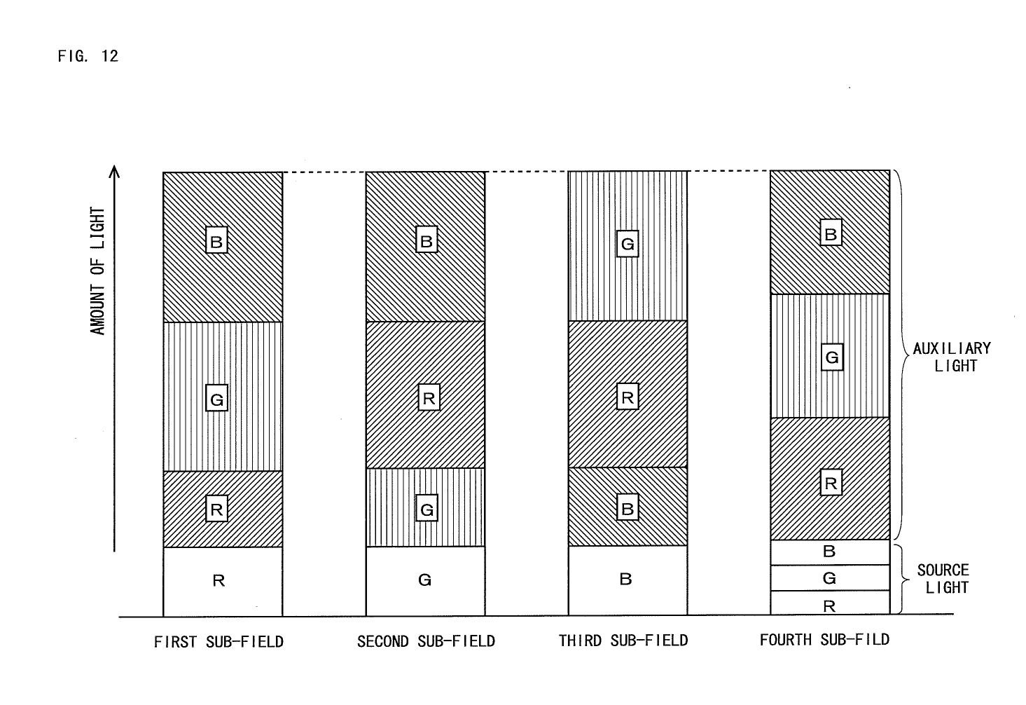

Described now is an adjustment method by which the amount of light emitted by each LED of the auxiliary light source 90 is adjusted such that on the back side of the display 10, chromaticity coordinates of light match or approximately match the chromaticity coordinates (0.2585, 0.2914) for white in each sub-field period. FIG. 11 is a diagram illustrating lighting states of the backlight source and the auxiliary light source 90 for each sub-field period.

As shown in FIG. 11, in the first sub-field period, the red LED of the backlight source 80 is lit up, so that a first polarization component included in the red source light is transmitted through to the back side of the display 10. Accordingly, to generate cyan, which is a complementary color to red, the auxiliary light source 90 lights up the red LED simultaneously with the green and blue LEDs so as to emit not only green and blue light but also red light, which is the same color as the source light. In this case, the amount of red auxiliary light emitted by the auxiliary light source 90 is determined such that on the back side, the sum of the amount of red source light, i.e., the amount of first polarization component, and the amount of red auxiliary light emitted by the auxiliary light source 90 is equal to or approximately equal to the amount of green or blue auxiliary light.

In the second sub-field period, the green LED of the backlight source 80 is lit up, so that a first polarization component included in the green source light is transmitted through to the back side of the display 10. Accordingly, to generate magenta, which is a complementary color to green, the auxiliary light source 90 lights up the red LED simultaneously with the green and blue LEDs so as to emit not only red and blue light but also green light, which is the same color as the source light. In this case, the amount of green auxiliary light emitted by the auxiliary light source 90 is determined such that on the back side, the sum of the amount of green source light, i.e., the amount of first polarization component, and the amount of green auxiliary light emitted by the auxiliary light source 90 is equal to or approximately equal to the amount of red or blue auxiliary light.

In the third sub-field period, the blue LED of the backlight source 80 is lit up, so that a first polarization component included in the blue source light is transmitted through. to the back side of the display 10. Accordingly, to generate yellow, which is a complementary color to blue, the auxiliary light source 90 lights up the blue LED simultaneously with the red and green LEDs so as to emit not only red and green light but also blue light, which is the same color as the source light. In this case, the amount of blue auxiliary light emitted by the auxiliary light source 90 is determined such that on the back side, the sum of the amount of blue source light, i.e., the amount of first polarization component, and the amount of blue auxiliary light emitted by the auxiliary light source 90 is equal to or approximately equal to the amount of red or green auxiliary light.

In the fourth sub-field period, all of the red, green, and blue LEDs of the backlight source 80 are lit up, so that first polarization components included in the red, green, and blue source light are transmitted through to the back side of the display 10. Accordingly, to generate white light, the auxiliary light source 90 lights up the red, green, and blue LEDs simultaneously, thereby emitting red, green, and blue light simultaneously. In this case, the amounts of red, green, and blue auxiliary light emitted by the auxiliary light source 90 are determined such that the sum of these amounts is equal to or approximately equal to, for example, the amount of green or blue source light in the first sub-field.

In this manner, the backlight source 80 and the auxiliary light source 90 are driven such that the amount of red, green, and/or blue light to be transmitted through to the back side of the display 10 is equalized among the sub-field periods, with the result that the chromaticity coordinates of the light transmitted through to the back side are equal to or approximately equal to the chromaticity coordinates of white light. Thus, it is possible to inhibit color breakup which occurs when the observer on the back side changes his/her line of sight.

### 4.2 Effects

In the present embodiment, the auxiliary light source 90 is controlled so as to emit auxiliary light such that in each sub-field period, chromaticity coordinates of light transmitted through to the back side of the display 10 are equal to or approximately equal to the chromaticity coordinates of white light. Thus, even when the observer on the back side changes his/her line of sight, the observer sees less color breakup, and therefore, is less likely to feel stress.

### 4.3 Variant

The backlight source 80 and the auxiliary light source 90 have been described above as being driven such that in each sub-field period, the chromaticity coordinates of the light transmitted through to the back side of the display 10 are equal to or approximately equal to the chromaticity coordinates of white light. However, the color of the light transmitted through to the back side is not limited to white, so long as the color is consistent among the sub-field periods. Therefore, the chromaticity coordinates of the light transmitted through to the back side are simply required to be the same among the sub-field periods.

### 5. Fifth Embodiment

The configuration of a liquid crystal display device according to a fifth embodiment and the configuration of the display 10 included in the liquid crystal display device are the same as the configuration of the liquid crystal display device shown in FIG. 1 and the configuration of the display 10 shown in FIG. 4, respectively, except for the features to be described below, and therefore, any descriptions of the same features will be omitted. Moreover, as with the liquid crystal display device according to the third embodiment, the liquid crystal display device according to the present embodiment is driven in a field-sequential mode in which red, green, and blue light are sequentially emitted in a time-division manner, therefore, no color filters are formed on the surface of the liquid crystal panel 11, and the backlight source 80 and the auxiliary light source 90 light up the red, green, and blue LEDs sequentially in a time-division manner.

### 5.1 Method for Driving the Auxiliary Light Source

In the case where the liquid crystal display device is driven in a field-sequential mode, if the amount of light transmitted through to the back side of the display 10 varies among the sub-field periods, the observer on the back side perceives changes in the amount of light among the sub-field periods as flicker, so that the observer is more likely to feel stress.

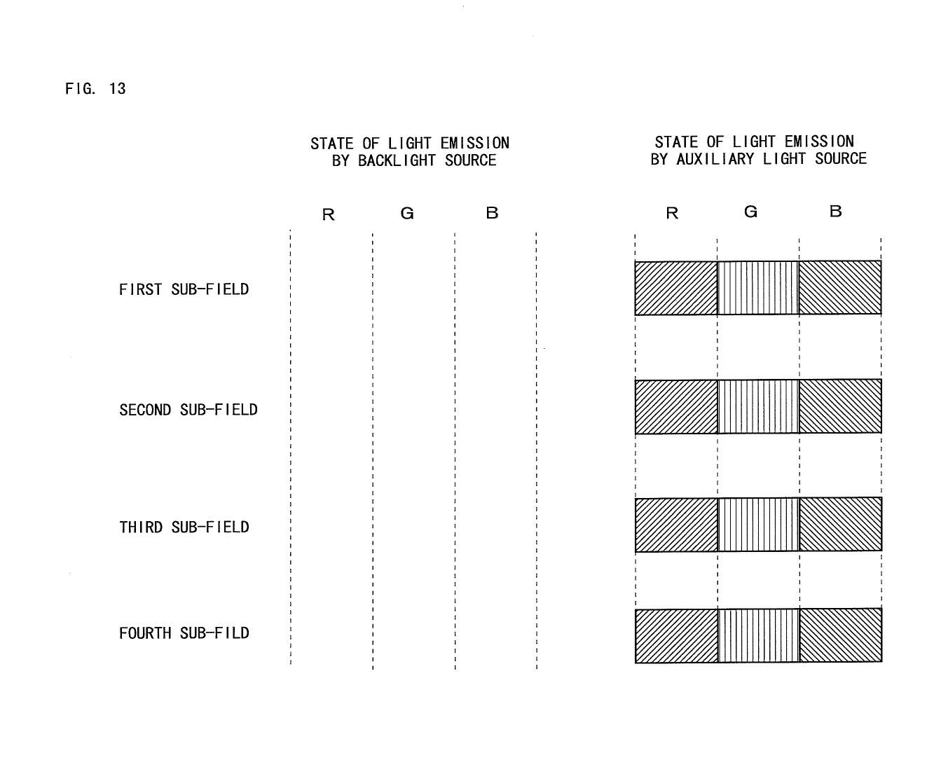

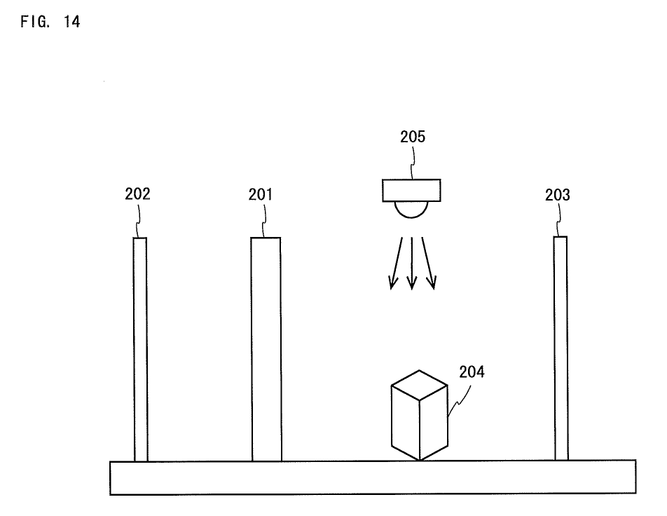

Therefore, in the case of the liquid crystal display device according to the present embodiment, the amount of light transmitted through to the back side is adjusted to be equal among the sub-field periods, whereby the observer on the back side sees less flicker. FIG. 12 is a diagram describing the sum of the amounts of source light and auxiliary light, both of which are transmitted through to the back side of the display 10, for each sub-field period. The light transmitted through to the back side of the display 10 consists of a first polarization component derived from the source light emitted by the backlight source 80 and transmitted through the reflective polarizer 14, and auxiliary light emitted in colors by the auxiliary light source 90. Therefore, the amounts of light emitted by the LEDs of the auxiliary light source 90 are adjusted such that the sum of the amounts of source light and auxiliary light, both of which are transmitted through to the back side, is constant among the sub-field periods.

As shown in FIG. 12, in the first sub-field period, the red LED of the backlight source 80 is lit up, so that a first polarization component included in the red light is transmitted through to the back side of the display 10. Accordingly, to generate cyan, which is a complementary color to red, the auxiliary light source 90 lights up the red LED simultaneously with the green and blue LEDs so as to emit not only green and blue light but also red light, which is the same color as the source light. In this case, the amount of red light emitted by the auxiliary light source 90 is determined such that on the back side, the sum of the amount of red source light, i.e., the amount of first polarization component, and the amount of red auxiliary light emitted by the auxiliary light source 90 is equal to or approximately equal to the amount of green or blue auxiliary light. As a result, in the first sub-field period, the sum of the amount of source light and auxiliary light, both of which are transmitted through to the back side, adds up to three times the amount of green or blue auxiliary light.

In the second sub-field period, the green LED of the backlight source 80 is lit up, so that a first polarization component included in the green light is transmitted through to the back side of the display 10. Accordingly, to generate magenta, which is a complementary color to green, the auxiliary light source 90 lights up the green LED simultaneously with the red and blue LEDs so as to emit not only red and blue light but also green light, which is the same color as the source light. In this case, the amount of green light emitted by the auxiliary light source 90 is determined such that on the back side, the sum of the amount of green source light, i.e., the amount of first polarization component, and the amount of green auxiliary light emitted by the auxiliary light source 90 is equal to or approximately equal to the amount of red or blue light. As a result, in the second sub-field period, as in the first sub-field period, the sum of the amounts of source light and auxiliary light, both of which are transmitted through to the back side, adds up to three times the amount of red or blue auxiliary light.

In the third sub-field period, the blue LED of the backlight source 80 is lit up, so that a first polarization component included in the blue light is transmitted through to the back side of the display 10. Accordingly, to generate yellow, which is a complementary color to blue, the auxiliary light source 90 lights up the blue LED simultaneously with the red and green LEDs so as to emit not only red and green light but also blue light, which is the same color as the source light. In this case, the amount of blue light emitted by the auxiliary light source 90 is determined such that on the back side, the sum of the amount of blue source light, i.e., the amount of first polarization component, and the amount of blue auxiliary light emitted by the auxiliary light source 90 is equal to or approximately equal to the amount of red or green auxiliary light. As a result, in the third sub-field period, as in the first sub-field period, the sum of the amounts of source light and auxiliary light, both of which are transmitted through to the back side, adds up to three times the amount of red or green auxiliary light.

In the fourth sub-field period, all of the red, green, and blue LEDs of the backlight source 80 are lit up, so that first polarization components included in the red, green, and blue light are transmitted through to the back side of the display 10. Accordingly, to generate white light, the auxiliary light source 90 lights up the red, green, and blue LEDs simultaneously, thereby simultaneously emitting red, green, and blue light in equal amounts. In this case, the amount of red light emitted by the auxiliary light source 90 is determined such that the sum of the amount of first polarization component included in the red source light and the amount of red auxiliary light emitted by the auxiliary light source 90 is equal to or approximately equal to, for example, the amount of green or blue auxiliary light in the first sub-field. The amounts of green and blue light are determined in the same manner as is the amount of red light.

In this manner, the auxiliary light source 90 is driven such that the sum of the amounts of source light and auxiliary light on the back side of the display 10, which is obtained for each of the sub-field periods, is equal or approximately equal among the sub-field periods.

### 5.2 Effects

In the present embodiment, the auxiliary light source 90 is controlled such that the sum of the amounts of light transmitted through to the back side of the display 10 is equal or approximately equal among the sub-field periods. As a result, the observer on the back side of the display 10 does not perceive any changes in the amount of light between the sub-field periods, and therefore, does not see flicker. Thus, the observer is less likely to feel stress.

### 6. Sixth Embodiment

The configuration of a liquid crystal display device according to a sixth embodiment and the configuration of the display 10 included in the liquid crystal display device are the same as the configuration of the liquid crystal display device shown in FIG. 1 and the configuration of the display 10 shown in FIG. 4, respectively, except for the features to be described below, and therefore, any descriptions of the same features will be omitted. Moreover, as with the liquid crystal display device according to the third embodiment, the liquid crystal display device according to the present embodiment is driven in a field-sequential mode in which red, green, and blue light are sequentially emitted in a time-division manner, therefore, no color filters are formed on the surface of the liquid crystal panel 11, and the backlight source 80 and the auxiliary light source 90 light up the red, green, and blue LEDs sequentially in a time-division manner.

### 6.1 Method for Driving the Auxiliary Light Source

FIG. 13 is a diagram illustrating the state of light emission by the auxiliary light source 90 for each sub-field period where the backlight source 80 is off. As shown in FIG. 13, in the present embodiment, as in the third through fifth embodiments, the red, green, and blue LEDs of the auxiliary light source 90 are sequentially lit up in each of the first through third sub-field periods, and all of the red, green, and blue LEDs are lit up simultaneously in the fourth sub-field period. In this case, the amounts of light for the LEDs of the auxiliary light source 90 are determined by any of the methods described in the third through fifth embodiments.

Furthermore, even in the case where all LEDs of the backlight source 80 are off in the first through fourth sub-field periods, if the auxiliary light source 90 emits light sequentially in cyan, magenta, and yellow, which are complementary colors, in the first through third sub-field periods in a time-division. manner, color breakup occurs when the observer on the back side of the display 10 changes his/her line of sight.

Therefore, the red, green, and blue LEDs of the auxiliary light source 90 are lit up simultaneously even when all LEDs of the back fight source 80 are off in the first through fourth sub-field periods. As a result, in the first through fourth sub-field periods, white light transmitted from the auxiliary light source 90 to the back side is the only light on the back side.

### 6.2 Effects

In the present embodiment, when the backlight source 80 is off, the white light emitted by the auxiliary light source 90 is the only that is transmitted through to the back side in any of the first through fourth sub-field periods. Thus, even when the observer on the back side of the display 10 changes his/her line of sight, the observer does not see color breakup, and therefore, is less likely to feel stress.

### 6.3 Variant

In the foregoing, the light that is transmitted through to the back side in the first through fourth sub-field periods is the white light emitted by the auxiliary light source 90. However, the color of the auxiliary light emitted by the auxiliary light source 90 is not limited to white, so long as the color is consistent among the sub-field periods.

### INDUSTRIAL APPLICABILITY

The present invention suitable for display devices provided with displays through which backgrounds can be seen.

### DESCRIPTION OF THE REFERENCE CHARACTERS

10 display (display portion)
11 liquid crystal panel
13 absorptive polarizer
14 reflective polarizer
15 light guide
30 display control circuit (drive control circuit)
40 scanning signal line driver circuit (drive control circuit)
50 data signal line driver circuit (drive control circuit)
60 light source driver circuit
70 auxiliary light source driver circuit
80 backlight source
80r, 80a, 80b red, green, and blue LEDs (light-emitting elements)
90 auxiliary light source
90r, 90g, 90b red, green, and blue LEDs (light-emitting elements)

1. A display device having a function of allowing a background to be seen through from a front side, the device comprising:
a backlight source configured to emit source light;
a display portion configured to display an image by transmitting the source light emitted by the backlight source therethrough in accordance with an externally provided image signal, the display portion being capable of transmitting background light incident from a back side therethrough to the front side;
a drive control circuit configured to drive the display portion;
an auxiliary light source configured to emit auxiliary light toward a back of the display portion; and
an auxiliary light source driver circuit configured to drive the auxiliary light source, wherein,
the auxiliary light source driver circuit drives the auxiliary light source in synchronization with the backlight source.

2. The display device according to claim 1, wherein the auxiliary light source driver circuit drives the auxiliary light source such that the light is brighter when the backlight source is off than when the backlight source is on.

3. The display device according to claim 2, wherein the auxiliary light source driver circuit drives the auxiliary light source such that the sum of the amount of source light emitted by the backlight source and transmitted through to the back side and the amount of auxiliary light provided when the backlight source is on equals the amount of auxiliary light provided when the backlight source is off.

4. The display device according to claim 1, wherein, the drive control circuit provides the display portion with image data generated on the basis of the image signal for each of a plurality of sub-field periods delineated by dividing one frame period of the image
the backlight source and the auxiliary light source each include a plurality of light-emitting elements configured to emit light in at least three respectively different colors,
the backlight source emits source light by lighting up at least one of the light-emitting elements for each of the sub-field periods in synchronization with the drive control circuit providing the display portion with the image data generated on the basis of the image signal, and
the auxiliary light source driver circuit causes at least one of the light-emitting elements included in the auxiliary light source to emit auxiliary light in synchronization with the backlight source for each of the sub-field periods, such that the auxiliary light has a complementary color to the source light emitted by the backlight source.

5. The display device according to claim 4, wherein the auxiliary light source driver circuit drives the auxiliary light source such that light consisting of the source light transmitted from the backlight source to the back side and the auxiliary light emitted by the auxiliary light source toward the back side has chromaticity coordinates of the same color among the sub-field periods.

6. The display device according to claim 4, wherein the auxiliary light source driver circuit drives the auxiliary light source to emit auxiliary light such that the sum of the amount of light transmitted from the backlight source to the back side and the amount of auxiliary light emitted by the auxiliary light source toward the back side is constant among the sub-field periods.

7. The display device according to any of claims 4, wherein the auxiliary light source driver circuit drives the auxiliary light source to emit auxiliary light in a consistent color among the sub-field periods where the backlight source is off.

8. The display device according to any of claims 1, wherein,
the display portion is a liquid crystal panel, and
the light-emitting elements included in each of the backlight source and the auxiliary light source are light-emitting elements respectively emitting red, green, and blue light.
